(19) United States
(12) Patent Application Publication
(10) Pub. No.: US 2019/0077661 A1
(43) Pub. Date: Mar. 14, 2019

(54) BORON NITRIDE FOAM, METHODS OF MANUFACTURE THEREOF, AND ARTICLES CONTAINING THE BORON NITRIDE FOAM

(71) Applicant: ROGERS CORPORATION, CHANDLER, AZ (US)

(72) Inventors: RANDALL MORGAN ERB, NEWTON, MA (US); ANVESH GURIJALA, LANCASTER, MA (US); LI ZHANG, Glen Mills, PA (US); QIAOCHU HAN, WOBURN, MA (US)

(21) Appl. No.: 16/130,052

(22) Filed: Sep. 13, 2018

Related U.S. Application Data
(60) Provisional application No. 62/558,585, filed on Sep. 14, 2017.

(51) Int. Cl. C01B 21/064; B01F 3/04; B01F 3/22; B01F 17/00

(52) U.S. Cl. CPC C01B 21/0648; B01F 3/04446; B01F 3/04106; B01F 3/0446; B01F 3/2215; C01P 2004/20; B01F 17/005; C01P 2006/10; C01P 2006/32; C01P 2006/40; B01F 17/0028

(57) ABSTRACT

A method of preparing a boron nitride foam includes flowing a gaseous medium along a flow path; introducing into the flow path a flowable composition that includes boron nitride sheets, a suspending agent, and optionally a surfactant to foam the flowable composition in the flow path; outputting the foamed flowable composition from the flow path; and solidifying the outputted flowable composition to provide the boron nitride foam; wherein the boron nitride foam has a structure defined by a three-dimensional network of interconnected cells defined by cell walls, wherein the cell walls include the boron nitride sheets.

### CROSS-REFERENCE TO RELATED APPLICATIONS

This application claims priority to U.S. Provisional Application 62/558,585 filed on Sep. 14, 2017, which is incorporated herein by reference in its entirety.

### FIELD OF THE DISCLOSURE

The present disclosure is related to foam materials, particularly foams useful in high-energy absorption and management applications, including kinetic and thermal energy.

### BACKGROUND

Cellular structures can enhance the mechanical properties of materials, including their ability to maintain structural integrity upon deformation. Such structures are particularly useful for thermal management applications such as heat transfer. The pores of porous structures are an important factor in determining their thermal properties. Graphene foams, for example, are employed in thermal management of high power electronic and optoelectronic devices.

Boron nitride foams are three-dimensional networks of interconnected open cells defined by cell walls which include boron nitride sheets. While superelastic boron nitride foams have been reported, robust, high yield processes of making these materials have not yet been reported.

There accordingly remains a need in the art for methods of producing boron nitride foams. It would be a further advantage if the methods were robust and suitable for large-scale production.

### BRIEF SUMMARY

In an aspect, a method of preparing a boron nitride foam comprises flowing a gaseous medium along a flow path; introducing into the flow path a flowable composition comprising boron nitride sheets, a suspending agent and optionally a surfactant, to foam the flowable composition in the flow path; outputting the foamed flowable composition from the flow path; and solidifying the outputted flowable composition to provide the boron nitride foam; wherein the boron nitride foam comprises a structure defined by a three-dimensional network of interconnected cells defined by cell walls, wherein the cell walls comprise the boron nitride sheets.

The above-described and other features will be appreciated and understood by those skilled in the art from the following detailed description, drawings, and appended claims.

### BRIEF DESCRIPTION OF THE DRAWINGS

The following Figures are illustrative.

FIG. 1 illustrates a microfluidic device to produce a liquid polymer-reinforced boron nitride foam.

FIG. 2 illustrates a liquid boron nitride foam (left panel) and a solid boron nitride foam (right panel).

FIG. 3 illustrates a cross-section of a boron nitride foam cut across the short axis of the cells.

FIG. 4 illustrates a section of the boron nitride foam of FIG. 3 cut across the longer axis of the cells.

FIG. 5 illustrates a boron nitride foam having a honeycomb structure.

FIG. 6 illustrates cross-sections of foams having different types of honeycomb structures.

### DETAILED DESCRIPTION

Described herein are novel methods of producing boron nitride foams, including polymer-reinforced boron nitride foams, and more particularly superelastic boron nitride foams. The methods described herein are particularly suitable for large-scale production of boron nitride foams, and in some cases can be scaled to roll-to-roll production. The methods can provide high-impact materials suitable for thermal management applications where, for example, cyclic loading is present.

An embodiment of a method to produce a boron nitride foam is a two-step process that includes fluidic foaming followed by solidification of the foam. Such methods have been used to produce crystalline polyurethane foams, as described, for example, by A. Tstouri, et al., in “Generation of porous solids with well-controlled morphologies by combining foaming and flow chemistry on a Lab-on-a-Chip” Colloids and Surfaces A: Physicochem. and Eng. Aspects, (2012), doi:10.1016/j.colsurfa.2012.02.048; and by A. Tstouri, et al., in “Generation of Crystalline Polyurethane Foams Using Millifluidic Lab-on-a-Chip Technologies” Adv. Eng. Mat., 2013, vol. 15, pp. 1086-1098. In fluidic foaming, gas bubbles that are the same size pack together in a hexagonal packing configuration, referred to as bubble rafting. Fluidic devices can create stable, monodisperse gas bubbles that range in size from 1 μm to 3 mm, and larger bubbles (>100 μm) can also be produced.

In an embodiment, a method of preparing a boron nitride foam comprises flowing a gaseous medium along a flow path; introducing into the flow path a flowable composition comprising boron nitride sheets and a suspending agent to foam the flowable composition in the flow path; outputting the foamed flowable composition from the flow path; and solidifying the outputted flowable composition to provide the boron nitride foam; wherein the boron nitride foam comprises a structure defined by a three-dimensional network of interconnected cells defined by cell walls, wherein the cell walls comprise the boron nitride sheets.

The method is further illustrated in FIG. 1, which illustrates an exemplary microfluidic device. The method can be performed, for example, in a fluidic device, e.g., a microfluidic, a millifluidic, or a macrofluidic device. The fluidic device can be in communication with one or more of a foaming unit, a mixing unit and a shaping unit. The foaming unit provides gas bubbles which form pores in the resulting foam. The mixing unit allows mixing of fluids from different inlets. The shaping chamber allows for shaping of the final solid foam product.

As used herein, a microfluidic device is a device suitable for processing small volumes of liquid and/or gaseous fluid, such as nanoliter and picoliter volumes of fluid. In general, microfluidic devices have dimensions of millimeters to nanometers, and comprise one or more micro channels, as well as inlet and outlet ports that allow fluids to pass into and out of the microfluidic device. A microfluidic chip, for example, is a microfluidic device into which a network of microchannels has been molded or patterned. The width of the microchannel can be 50 microns to 2 millimeters, or less.

A macrofluidic device may also be utilized. A macrofluidic device has a flow channel with a width of greater than 2 mm to 10 mm.

In an aspect, the flow path is through a channel and the flowable composition is flowed into the channel through an inlet to the channel. Multiple parallel channels can be employed.

The channel comprises one or more inlets through which reagents in a flowable composition are flowed into the flow path. The flowable composition optionally comprises a polymer binder composition or a polymer binder precursor composition, in addition to the boron nitride sheets. The polymer binder composition or polymer binder precursor composition and the boron nitride sheets can be flowed through the same or different inlets.

Exemplary gaseous media to flow through the channel include air, nitrogen, and the like. It is also possible to use physical blowing agents known for use in foaming polymeric materials. These blowing agents can be various hydrocarbons, ethers, esters, (including partially halogenated hydrocarbons, ethers, and esters), and so forth, as well as combinations comprising at least one of the foregoing. Exemplary physical blowing agents include the CFC's (chlorofluorocarbons) such as 1,1-dichloro-1-fluoroethane, 1,1-dichloro-2,2,2-trifluoro-ethane, monochlorodifluoromethane, and 1-chloro-1,1-difluoroethane; the FC's (fluorocarbons) such as 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, and pentafluoroethane; the FE's (fluoroethers) such as methyl-1,1,1-trifluoroethylether and difluoromethyl-1,1,1-trifluoroethylether; hydrocarbons such as n-pentane, isopentane, and cyclopentane.

The gaseous medium is used (flowed) in an amount sufficient to give the resultant foam the desired bulk density. In an embodiment, the gaseous medium is flowed at a constant speed. Flowing the gaseous medium at a constant speed can provide pores in the foam having substantially the same size. The flow speeds depend on the device and binder composition used.

The flowable composition preferably has a viscosity that provides suspension of the boron nitride sheets and does not allow substantial sedimentation of the boron nitride sheets. Exemplary viscosities are I centipoise (cP) to 5000 cP.

The flowable composition comprises boron nitride sheets, e.g., hexagonal boron nitride sheets, and a suspending agent. Suspending agents for the flowable composition include solvents as described below.

The flowable composition optionally includes a polymer binder composition or a polymer binder precursor composition, such that the boron nitride foam is a polymer-reinforced boron nitride foam.

The polymer binder composition or polymer binder precursor composition comprises a polymer such as a thermoplastic or thermoset polymer, and optionally a surfactant. Exemplary polymers include a wide variety of thermoplastic or thermoset polymers.

Examples of thermoplastic polymers include polyacetals, polyacrylates, polyacrylics, polyalkylene oxides (e.g., polyethylene oxide or polypropylene oxide), polyamideimides, polyamides, (e.g., aliphatic polyamides, polyphthalamides, and polyaramides), polyanhydrides, polyarylates, polyarylene ethers (e.g., polyphenylene ethers), polyarylene ether ketones (e.g., polyether ketones, polyether ether ketones, polyether ketone ketones, and the like), polyarylene sulfides (e.g., polyphenylene sulfides), polybenzoxazoles, polycarbonates (including polycarbonate copolymers such as polycarbonate-siloxanes, polycarbonate-esters, and polycarbonate-ester-siloxanes), polyesters (e.g., polyethylene terephthalates, polybutylene terephthalates and polyester copolymers such as polyester-ethers), polyetherimides (including copolymers such as polyetherimide-siloxane copolymers), polyether sulfones (also known as polyarylsulfones and polysulfones), polyimides (including copolymers such as polyimide-siloxane copolymers), polymethacrylates, polyolefins (e.g., polyethylenes, polypropylenes, and their copolymers such as ethylene-propylene rubbers), halogenated polyolefins (e.g., polytetrafluoroethylenes (PTFE), polychlorotrifluoroethylenes, and their copolymers, such as chlorinated ethylene-propylene), polyphthalides, polysilazanes, polysiloxanes, polystyrenes (including copolymers such as acrylonitrile-butadiene-styrene (ABS) and methyl methacrylate-butadiene-styrene (MBS)), polysulfides (e.g., polyphenylene sulfide), polysulfonamides, polysulfonates, polythioesters, polytriazines, polyureas, polyurethanes, polyvinyl alcohols, polyvinyl esters, polyvinyl ethers, polyvinyl halides, polyvinyl ketones, polyvinylidene fluorides, or the like, or a combination comprising at least one of the foregoing thermoplastic polymers. Polyamides (nylons, such as Nylon 6, Nylon 6,6, Nylon 6,10, Nylon 6,12, Nylon 11 or Nylon 12), polycarbonates, polyesters, polyetherimides, polyolefins, and polystyrene copolymers such as ABS, are especially useful in a wide variety of articles.

Examples of combinations of thermoplastic polymers that can be used include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, polyethylene terephthalate/polybutylene terephthalate, styrene-maleic anhydride/acrylonitrile-butadiene-styrene, polyether etherketone/polyethersulfone, styrene-butadiene rubber, polyethylene/nylon, polyethylene/polyacetal, ethylene propylene rubber (EPR), or a combination comprising at least one of the foregoing blends.

Examples of curable polymers that can be used include alkyds, epoxies, melamines, phenolics, polybutadienes (including copolymers thereof, e.g., poly(butadiene-isoprene), crosslinkable polyesters, polyurethanes, silicones, or a combination comprising at least one of the foregoing curable polymers.

The polymer binder composition or polymer binder precursor composition can be prepared using any number of conventional techniques known in the art, such as by compounding the composition, or stirring, mixing, or blending with the matrix polymer composition or a portion thereof (if liquid), or a solution of the matrix polymer composition.

When the flowable composition comprises a polymer, the suspending agent may comprise a solvent selected to dissolve or disperse the polymer binder or or polymer binder precursor. A non-exclusive list of possible solvents is xylene, toluene, methyl ethyl ketone, methyl isobutyl ketone, hexane, and higher liquid linear alkanes, such as heptane, octane, nonane, and the like, cyclohexane, isophorone, and various terpene-based solvents, or a combination comprising at least one of the foregoing.

The polymer binder composition or polymer binder precursor composition optionally comprises a surfactant.

The surfactant, when present, is selected to stabilize the foam, and is selected based on the polymer or polymer precursor binder composition used, the desired cell sizes, the desired foam stability, and like considerations. The surfactant can be anionic, cationic, amphoteric, or nonionic. Preferably the surfactant is anionic or nonionic.

Among the anionic surfactants that can be used are the alkali metal, alkaline earth metal, ammonium and amine salts, of organic sulfuric reaction products having in their molecular structure a C₈₋₃₆, or C₈₋₂₂, alkyl group and a sulfonic acid or sulfuric acid ester group. Included in the term alkyl is the alkyl portion of acyl radicals. Examples include the sodium, ammonium, potassium or magnesium alkyl sulfates, especially those obtained by sulfating C₈₋₁₈ alcohols, sodium or magnesium (C₉₋₁₅ alkyl) benzene or (C₉₋₁₅ alkyl) toluene sulfonates; sodium or magnesium C₁₀₋₂₀ paraffin sulfonates and C₁₀₋₂₀ olefin sulfonates; sodium C₁₀₋₂₀ alkyl glyceryl ether sulfonates, especially those ethers of alcohols derived from tallow and coconut oil; sodium coconut oil fatty acid monoglyceride sulfates and sulfonates, sodium, ammonium or magnesium salts of (C₈₋₁₂ alkyl) phenol ethylene oxide ether sulfates with 1 to 30 units of ethylene oxide per molecule; the reaction products of fatty acids esterified with isethionic acid and neutralized with sodium hydroxide where, for example, the fatty acids derived from coconut oil; sodium or potassium salts of fatty acid amides of a methyl tauride in which the fatty acids, for example, are derived from coconut oil and sodium or potassium beta-acetoxy or beta-acetamido-(C₈₋₂₂ alkane)sulfonates.

Among the specific anionic surfactants that can be used are C₈₋₂₂ alkyl sulfates (e.g., ammonium lauryl sulfate, sodium lauryl sulfate, sodium lauryl ether sulfate (SLES), sodium myreth sulfate, and dioctyl sodium sulfosuccinate), C₈₋₃₆ alkyl sulfonates comprising an organic sulfonate anion (e.g., octyl sulfonate, lauryl sulfonate, myristyl sulfonate, hexadecyl sulfonate, 2-ethylhexyl sulfonate, docosyl sulfonate, tetracosyl sulfonate, p-tosylate, butylphenyl sulfonate, dodecylphenyl sulfonate, octadecylphenyl sulfonate, and dibutylphenyl, sulfonate, diisopropyl naphthyl sulfonate, and dibutylnaphthyl sulfonate) and a cation (e.g., phosphonium or ammonium), C₈₋₃₆ perfluoroalkylsulfonates (e.g., perfluorooctanesulfonate (PFOS), perfluorobutanesulfonate), and linear C₇₋₃₆ alkylbenzene sulfonates (LABS) (e.g., sodium dodecylbenzenesulfonate). Alkyl ether sulfates having the formula RO(C₂H₄O)ₓSO₃M wherein R is a C₈₋₃₆ alkyl or alkenyl, x is 1 to 30, and M is a water-soluble cation. The alcohols can be derived from natural fats, e.g., coconut oil or tallow, or can be synthetic. In some embodiments, the surfactant comprises a (C₈₋₃₆ alkyl)benzene sulfonate, (C₈₋₃₆alkyl) sulfonate, mono- or di(C₈₋₃₆alkyl) sulfosuccinate, (C₈₋₃₆ alkyl ether) sulfate, (C₈₋₃₆)alkyl ether sulfonate, perfluoro(C₂₋₁₂alkyl) sulfate, or perfluoro(C₂₋₁₂carboxylate), preferably sodium dodecyl sulfate, sodium lauryl sulfate, sodium laureth sulfate, sodium dioctyl sulfosuccinate, sodium dihexyl sulfosuccinate, perfluorooctane sulfonate, perfluorooctanoic acid, or sodium dodecylbenzenesulfonate, more preferably wherein the anionic surfactant is sodium dodecylbenzenesulfonate.

Nonionic surfactants can also be used and can include a C₈₋₂₂ aliphatic alcohol ethoxylate having 1 to 25 moles of ethylene oxide; and preferably C₁₀₋₂₀ aliphatic alcohol ethoxylates having 2 to 18 moles of ethylene oxide. Examples of commercially available nonionic surfactants of this type are Tergitol™ 15-S-9 (a condensation product of C₁₁₋₁₅ linear secondary alcohol with 9 moles ethylene oxide), Tergitol™ 24-L-NMW (a condensation product of C₁₂₋₁₄ linear primary alcohol with 6 moles of ethylene oxide) with a narrow molecular weight distribution from Dow Chemical Company. This class of product also includes the Genapol® brands of Clariant GmbH.

Other nonionic surfactants that can be used include polyethylene, polypropylene, and polybutylene oxide condensates of C₆₋₁₂ alkyl phenols, for example compounds having 4 to 25 or 5 to 18 moles of ethylene oxide per mole of C₆₋₁₂ alkylphenol. Commercially available surfactants of this type include Igepal® CO-630, Triton™ X-45, X-114, X-100 and X102, Tergitol™ TMN-10, Tergitol™ TMN-100X, and Tergitol™ TMN-6 (all polyethoxylated 2,6,8-trimethyl-nonylphenols or mixtures thereof) from Dow Chemical Corporation, and the Arkopar®-N products from Hoechst AG.

Still others include the addition products of ethylene oxide with a hydrophobic base formed by the condensation of propylene oxide with propylene glycol. The hydrophobic portion of these compounds preferably has a molecular weight between 1500 and 1800 Daltons. Commercially available examples of this class of product are the Pluronic® brands from BASF and the Genapol® PF trademarks of Hoechst AG.

The addition products of ethylene oxide with a reaction product of propylene oxide and ethylenediamine can also be used. The hydrophobic moiety of these compounds is the reaction product of ethylenediamine and excess propylene oxide, and generally has a molecular weight of 2500 to 3000 Daltons. This hydrophobic moiety of ethylene oxide is added until the product contains from 40 to 80 wt % of polyoxyethylene and has a molecular weight of 5000 to 11,000 Daltons. Commercially available examples of this compound class are the Tetronic® brands from BASF and the Genapol® PN trademarks of Hoechst AG.

In some embodiments, the nonionic surfactant is a C₆₋₁₂ alkyl phenol having 4 to 25 moles of ethylene oxide per mole of C₆₋₁₂ alkylphenol, preferably 5 to 18 moles of ethylene oxide per mole of C₆₋₁₂ alkylphenol. In other embodiments, the surfactant comprises a biopolymer, for example gelatin, carrageenan, pectin, soy protein, lecithin, casein, collagen, albumin, gum arabic, agar, protein, cellulose and derivatives thereof, a polysaccharide and derivatives thereof, starch and derivatives thereof, or the like, or a combination comprising at least one of the foregoing.

Organosilicone surfactants are especially useful, for example with polyurethane precursor compositions. Example include a copolymer consisting essentially of SiO₂ (silicate) units and (CH₃)₃SiO_{0.5} (trimethylsiloxy) units in a molar ratio of silicate to trimethylsiloxy units of 0.8:1 to 2.2:1, or, more specifically, 1:1 to 2.0:1. Another organosilicone surfactant stabilizer is a partially cross-linked siloxane-polyoxyalkylene block copolymer and mixtures thereof wherein the siloxane blocks and polyoxyalkylene blocks are linked by silicon to carbon, or by silicon to oxygen to carbon, linkages. The siloxane blocks comprise hydrocarbon-siloxane groups and have an average of at least two valences of silicon per block combined in the linkages. At least a portion of the polyoxyalkylene blocks comprise oxyalkylene groups and are polyvalent, i.e., have at least two valences of carbon and/or carbon-bonded oxygen per block combined in said linkages. Any remaining polyoxyalkylene blocks comprise oxyalkylene groups and are monovalent, i.e., have only one valence of carbon or carbon-bonded oxygen per block combined in said linkages. Additional organopolysiloxane-polyoxyalkylene block copolymers include those described in U.S. Pat. Nos. 2,917,480 and 3,057,901.

Combinations comprising at least one of the foregoing surfactants can be used. The amount of the surfactant used as a foam stabilizer can vary over wide limits, e.g., 0.5 wt % to 10 wt % or more, based on the amount of the polymer or polymer precursor, or, more specifically, 1.0 wt % to 6.0 wt %.

In still other embodiments, a surfactant is not used. Without being bound by theory, it is believed that the boron nitride foam sheets are effective to stabilize the foams in the absence of a surfactant.

As described above, the foams are produced via the introduction of the flowable composition into the flow path comprising the gaseous medium. In an embodiment, no other foaming method or agent is present or used. In other embodiments, a chemical blowing agent can be present in the polymer binder or polymer binder precursor composition. Chemical blowing agents include, for example, water, and chemical compounds that decompose with a high gas yield under specified conditions, for example within a narrow temperature range. Exemplary chemical blowing agents include water, azoisobutyronitrile, azodicarbonamide (i.e. azo-bis-formamide) and barium azodicarboxylate; substituted hydrazines (e.g., diphenylsulfone-3,3′-disulfohydrazide, 4,4′-hydroxy-bis-(benzenesulfohydrazide), trihydrazinotriazine, and aryl-bis-(sulfohydrazide)); semicarbazides (e.g., p-tolylene sulfonyl semicarbazide an d4,4′-hydroxy-bis-(benzenesulfonyl semicarbazide)); triazoles (e.g., 5-morpholyl-1,2,3,4-thiatriazole); N-nitroso compounds (e.g., N,N′-dinitrosopentamethylene tetramine and N,N-dimethyl-N,N′-dinitrosophthalmide); benzoxazines (e.g., isatoic anhydride); as well as combinations comprising at least one of the foregoing, such as, sodium carbonate/citric acid mixtures. The amount of chemical blowing agent can vary depending on the agent and the desired foam density. In general, these blowing agents are used in an amount of 0.1 wt % to 10 wt %, based upon a total weight of the reactive composition. When water is used as at least one of the blowing agent(s) (e.g., in an amount of 0.1 wt % to 8 wt % based upon the total weight of reactive composition), it is generally desirable to control the curing reaction by selectively employing catalysts.

When the flowable composition comprises curable polymer binder precursor composition, a catalyst for cure of the polymer binder precursor can be present. The particular catalyst used will depend on the type of curable precursor. For example, exemplary catalysts for cure of ethylenically unsaturated systems, including some silicone precursor compositions, include ketone peroxides, diacyl peroxides, peroxyesters, peroxyketals, hydroperoxides, peroxydicarbonates and peroxymonocarbonates, and the like. Platinum- or tin-containing catalysts can be used for other silicone precursor compositions. Hardeners and catalysts for epoxy precursor compositions are also known and have been described in the art.

Preferably the curable precursor composition is for the formation of a polyurethane. In general, polyurethane foams can be formed from precursor compositions comprising an organic isocyanate component reactive with an active hydrogen-containing component(s), an optional surfactant, and a catalyst. The organic isocyanate components used in the preparation of polyurethane foams generally comprises polyisocyanates having the general formula Q(NCO)ᵢ, wherein “i” is an integer having an average value of greater than two, and Q is an organic radical having a valence of “i”. Q can be a substituted or unsubstituted hydrocarbon group (e.g., an alkane or an aromatic group of the appropriate valency). Q can be a group having the formula Q¹-Z-Q¹ wherein Q¹ is an alkylene or arylene group and Z is —O—, —O-Q¹-S, —CO—, —S—, —S-Q¹-S—, —SO— or —SO₂—. Exemplary isocyanates include hexamethylene diisocyanate, 1,8-diisocyanato-p-methane, xylyl diisocyanate, diisocyanatocyclohexane, phenylene diisocyanates, tolylene diisocyanates, including 2,4-tolylene diisocyanate, 2,6-tolylene diisocyanate, and crude tolylene diisocyanate, bis(4-isocyanatophenyl)methane, chlorophenylene diisocyanates, diphenylmethane-4,4′-diisocyanate (also known as 4,4′-diphenyl methane diisocyanate, or MDI) and adducts thereof, naphthalene-1,5-diisocyanate, triphenylmethane-4,4′,4″-triisocyanate, isopropylbenzene-alpha-4-diisocyanate, polymeric isocyanates such as polymethylene polyphenylisocyanate, and combinations comprising at least one of the foregoing isocyanates.

Q can also represent a polyurethane radical having a valence of “i”, in which case Q(NCO)ᵢ is a composition known as a prepolymer. Such prepolymers are formed by reacting a stoichiometric excess of a polyisocyanate as set forth hereinbefore and hereinafter with an active hydrogen-containing component as set forth hereinafter, especially the polyhydroxyl-containing materials or polyols described below. Usually, for example, the polyisocyanate is employed in proportions of 30 percent to 200 percent stoichiometric excess, the stoichiometry being based upon equivalents of isocyanate group per equivalent of hydroxyl in the polyol. The amount of polyisocyanate employed will vary slightly depending upon the nature of the polyurethane being prepared.

The active hydrogen-containing component can comprise polyether polyols and polyester polyols. Exemplary polyester polyols are inclusive of polycondensation products of polyols with dicarboxylic acids or ester-forming derivatives thereof (such as anhydrides, esters and halides), polylactone polyols obtainable by ring-opening polymerization of lactones in the presence of polyols, polycarbonate polyols obtainable by reaction of carbonate diesters with polyols, and castor oil polyols. Exemplary dicarboxylic acids and derivatives of dicarboxylic acids which are useful for producing polycondensation polyester polyols are aliphatic or cycloaliphatic dicarboxylic acids such as glutaric, adipic, sebacic, fumaric and maleic acids; dimeric acids; aromatic dicarboxylic acids such as phthalic, isophthalic and terephthalic acids; tribasic or higher functional polycarboxylic acids such as pyromellitic acid; as well as anhydrides and second alkyl esters, such as maleic anhydride, phthalic anhydride and dimethyl terephthalate.

Additional active hydrogen-containing components are the polymers of cyclic esters. The preparation of cyclic ester polymers from at least one cyclic ester monomer is well documented in the patent literature as exemplified by U.S. Pat. Nos. 3,021,309 through 3,021,317; 3,169,945; and 2,962,524. Exemplary cyclic ester monomers include δ-valerolactone; ε-caprolactone; zeta-enantholactone; and the monoalkyl-valerolactones (e.g., the monomethyl-, monoethyl-, and monohexyl-valerolactones). In general the polyester polyol can comprise caprolactone based polyester polyols, aromatic polyester polyols, ethylene glycol adipate based polyols, and combinations comprising at least one of the foregoing polyester polyols, and especially polyester polyols made from ε-caprolactones, adipic acid, phthalic anhydride, terephthalic acid and/or dimethyl esters of terephthalic acid.

The polyether polyols are obtained by the chemical addition of alkylene oxides (such as ethylene oxide, propylene oxide, and so forth, as well as combinations comprising at least one of the foregoing), to water or polyhydric organic components (such as ethylene glycol, propylene glycol, trimethylene glycol, 1,2-butylene glycol, 1,3-butanediol, 1,4-butanediol, 1,5-pentanediol, 1,2-hexylene glycol, 1,10-decanediol, 1,2-cyclohexanediol, 2-butene-1,4-diol, 3-cyclohexene-1,1-dimethanol, 4-methyl-3-cyclohexene-1,1-dimethanol, 3-methylene-1,5-pentanediol, diethylene glycol, (2-hydroxyethoxy)-1-propanol, 4-(2-hydroxyethoxy)-1-butanol, 5-(2-hydroxypropoxy)-1-pentanol, 1-(2-hydroxymethoxy)-2-hexanol, 1-(2-hydroxypropoxy)-2-octanol, 3-allyloxy-1,5-pentanediol, 2-allyloxymethyl-2-methyl-1,3-propanediol, [4,4-pentyloxy)-methyl]-1,3-propanediol, 3-(o-propenylphenoxy)-1,2-propanediol, 2,2′-diisopropylidenebis(p-phenyleneoxy)diethanol, glycerol, 1,2,6-hexanetriol, 1,1,1-trimethylolethane, 1,1,1-trimethylolpropane, 3-(2-hydroxyethoxy)-1,2-propanediol, 3-(2-hydroxypropoxy)-1,2-propanediol, 2,4-dimethyl-2-(2-hydroxyethoxy)-methylpentanediol-1,5; 1,1,1-tris[2-hydroxyethoxy) methyl]-ethane, 1,1,1-tris[2-hydroxypropoxy)-methyl] propane, diethylene glycol, dipropylene glycol, pentaerythritol, sorbitol, sucrose, lactose, alpha-methylglucoside, alpha-hydroxyalkylglucoside, novolac resins, phosphoric acid, benzenephosphoric acid, polyphosphoric acids such as tripolyphosphoric acid and tetrapolyphosphoric acid, ternary condensation products, and so forth, as well as combinations comprising at least one of the foregoing). The alkylene oxides employed in producing polyoxyalkylene polyols normally have 2 to 4 carbon atoms. Propylene oxide and mixtures of propylene oxide with ethylene oxide are preferred. The polyols listed above can be used per se as the active hydrogen component. In an embodiment, the polyol desirably used has a repeat unit of each of PO (propylene oxide) and/or PTMG (tetrahydrofuran subjected to ring-opening polymerization), or the like. In a specific embodiment, the amount of EO (ethylene oxide; (CH₂CH₂O)ₙ) is minimized in order to improve the hygroscopic properties of the foam. Specifically, the percentage of an EO unit (or an EO unit ratio) in a polyol can be less than or equal to 20%. For example, when a polyol to be used merely consists of a PO-Unit and an EO Unit, this polyol is set to be within the range of [the PO Unit]:[the EO Unit]=100:0 to 80:20. The percentage of an EO unit is referred to as “EO content”.

A useful class of polyether polyols is represented generally by the following formula: RROCHₙH₂ₙ)_{z}OH]ₐ wherein R is hydrogen or a polyvalent hydrocarbon radical; “a” is an integer equal to the valence of R, “n” in each occurrence is an integer of 2 to 4 inclusive (specifically 3), and “z” in each occurrence is an integer having a value of 2 to 200, or, more specifically, 15 to 100. Desirably, the polyether polyol comprises a mixture of one or more of dipropylene glycol, 1,4-butanediol, and 2-methyl-1,3-propanediol, and so forth.

Another type of active hydrogen-containing materials that can be used is polymer polyol compositions obtained by polymerizing ethylenically unsaturated monomers in a polyol as described in U.S. Pat. No. 3,383,351. Exemplary monomers for producing such compositions include acrylonitrile, vinyl chloride, styrene, butadiene, vinylidene chloride, and other ethylenically unsaturated monomers. The polymer polyol compositions can contain 1 weight percent (wt %) to 70 wt %, or, more specifically, 5 wt % to 50 wt %, and even more specifically, 10 wt % to 40 wt % monomer polymerized in the polyol, where the weight percent is based on the total weight of polyol. Such compositions are conveniently prepared by polymerizing the monomers in the selected polyol at a temperature of 40° C. to 150° C. in the presence of a free radical polymerization catalyst such as peroxides, persulfates, percarbonate, perborates, azo compounds, and combinations comprising at least one of the foregoing.

The active hydrogen-containing component can also contain polyhydroxyl-containing compounds, such as hydroxyl-terminated polyhydrocarbons (U.S. Pat. No. 2,877,212); hydroxyl-terminated polyformals (U.S. Pat. No. 2,870,097); fatty acid triglycerides (U.S. Pat. Nos. 2,833,730 and 2,878,601); hydroxyl-terminated polyesters (U.S. Pat. Nos. 2,698,838, 2,921,915, 2,591,884, 2,866,762, 2,850,476, 2,602,783, 2,729,618, 2,779,689, 2,811,493, 2,621,166 and 3,169,945); hydroxymethyl-terminated perfluoromethylenes (U.S. Pat. Nos. 2,911,390 and 2,902,473); hydroxyl-terminated polyalkylene ether glycols (U.S. Pat. No. 2,808,391; British Pat. No. 733,624); hydroxyl-terminated polyalkylenearylene ether glycols (U.S. Pat. No. 2,808,391); and hydroxyl-terminated polyalkylene ether triols (U.S. Pat. No. 2,866,774).

The polyols can have hydroxyl numbers that vary over a wide range. In general, the hydroxyl numbers of the polyols, including other cross-linking additives, if used, can be 28 to 1,000, and higher, or, more specifically, 100 to 800. The hydroxyl number is defined as the number of milligrams of potassium hydroxide required for the complete neutralization of the hydrolysis product of the fully acetylated derivative prepared from 1 gram of polyol or mixtures of polyols with or without other cross-linking additives. The hydroxyl number can also be defined by the equation:

$$OH = \frac{56.1 \times 1000 \times f}{{M}_{W}}$$

wherein: OH is the hydroxyl number of the polyol,
f is the average functionality, that is the average number of hydroxyl groups per molecule of polyol, and
   M_{W} is the average molecular weight of the polyol.

Exemplary catalysts capable of catalyzing the reaction of the isocyanate component with the active hydrogen-containing component include phosphines; tertiary organic amines; organic and inorganic acid salts of, and organometallic derivatives of: bismuth, lead, tin, iron, antimony, uranium, cadmium, cobalt, thorium, aluminum, mercury, zinc, nickel, cerium, molybdenum, vanadium, copper, manganese, and zirconium; as well as combinations comprising at least one of the foregoing. Specific examples of such catalysts include dibutyltin dilaurate, dibutyltin diacetate, stannous octoate, lead octoate, cobalt naphthenate, triethylamine, triethylenediamine, N,N,N′,N′-tetramethylethylenediamine, 1,1,3,3-tetramethylguanidine, N,N,N′N′-tetramethyl-1,3-butanediamine, N,N-dimethylethanolamine, N,N-diethylethanolamine, 1,3,5-tris (N,N-dimethylaminopropyl)-s-hexahydrotriazine, o- and p-(dimethylaminomethyl) phenols, 2,4,6-tris(dimethylaminomethyl) phenol, N,N-dimethylcyclohexylamine, pentamethyldiethylenetriamine, 1,4-diazobicyclo [2.2.2] octane, N-hydroxyl-alkyl quaternary ammonium carboxylates and tetramethylammonium formate, tetramethylammonium acetate, tetramethylammonium 2-ethylhexanoate, and so forth, as well as combinations comprising at least one of the foregoing catalysts.

Metal acetyl acetonates based on metals such as aluminum, barium, cadmium, calcium, cerium (III), chromium (III), cobalt (II), cobalt (III), copper (II), indium, iron (II), lanthanum, lead (II), manganese (II), manganese (III), neodymium, nickel (II), palladium (II), potassium, samarium, sodium, terbium, titanium, vanadium, yttrium, zinc and zirconium. A common catalyst is bis(2,4-pentanedionate) nickel (II) (also known as nickel acetylacetonate or diacetylacetonate nickel) and derivatives thereof such as diacetonitrilediacetylacetonato nickel, diphenylnitrilediacetylacetonato nickel, bis(triphenylphosphine)diacetyl acetylacetonato nickel, and so forth, can be employed. Ferric acetylacetonate (FeAA) is particularly preferred, due to its relative stability, good catalytic activity, and lack of toxicity. Added to the metal acetyl acetonate can be acetyl acetone (2,4-pentanedione), as disclosed in commonly assigned U.S. Pat. No. 5,733,945. In general, the ratio of metal acetyl acetonate to acetyl acetone is 2:1 on a weight basis.

The amount of catalyst present in the precursor composition can be 0.03 wt % to 3.0 wt %, based on the weight of the active hydrogen-containing component.

In an aspect, the boron nitride sheets are hexagonal boron nitride sheets. Generally, hexagonal boron nitride sheets include boron and nitrogen atoms forming interconnected hexagons. Each hexagon includes three boron atoms and three nitrogen atoms. Boron and nitrogen alternate in the hexagonal ring. Each of these atoms is trivalent and is covalently bonded to its neighbor. This arrangement results in stacked layers of interconnected hexagons. A layer of such covalently interconnected boron nitride hexagons is usually referred to as a sheet. Without wishing to be limited by theory, the formation of the cells as described above is believed to stem at least in part from the presence of weak van der Waals forces between hexagonal boron nitride sheets.

The boron nitride sheets that form the cell walls can include a functional group, preferably a carboxyl group, aldehyde group, ketone group, hydroxyl group, thiol group, amino group, amide group, sulfate group, sulfonate group, phosphate group, phosphonate group, halogen, (meth)acryloxy group, vinyl group, allyl group, tri(C₁₋₆ alkyl)silyl group, or a combination comprising at least one of the foregoing. In some embodiments, the cell walls are formed from only hexagonal boron nitride sheets.

The boron nitride sheets used to form the boron nitride foams can be in the form of, for example, a platelet, flake, whisker, fiber, or tube. Accordingly, hexagonal boron nitride particles, flakes, whiskers, fibers or tubes can be used. In an embodiment, the hexagonal boron nitride sheets are at least partially or fully exfoliated. The boron nitride sheets can be functionalized as described above, or contain additional materials, for example as dopants.

In the method, a flowable composition comprising gas bubbles is formed in the flow path through the channel, optionally with an anionic, nonionic, or cationic surfactant. In one aspect, foaming occurs when the flowable composition is introduced into the flow path comprising gas bubbles. In general, the bubble size is substantially similar to the cell size of the final product.

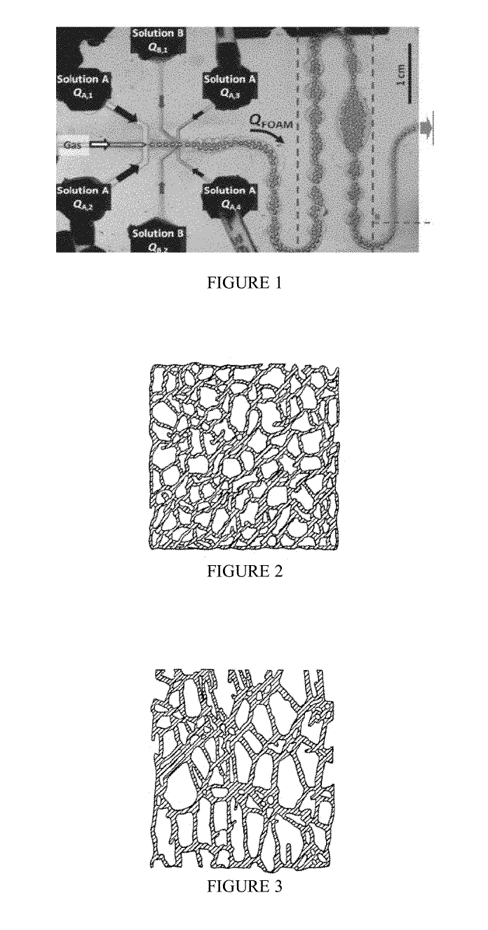

The flowable composition, e.g., comprising gas bubbles, is then outputted from the channel, as a flowable (e.g., liquid) foam composition as shown in the left panel of FIG. 2. The outputted flowable composition comprising gas bubbles is then solidified, for example in a foam shaping unit, to provide the boron nitride foam. As used herein, the foam composition does not flow when placed on a flat surface. In an aspect, flowable composition comprising gas bubbles is solidified in a container that provides a shape to the composition as illustrated in the right panel of FIG. 2. Solidifying can be done, for example, by cooling or curing.

A boron nitride foam has a structure defined by a three-dimensional network of interconnected cells which in some embodiments are further ordered. As used herein, a boron nitride foam comprises a structure defined by a three-dimensional network of interconnected cells defined by cell walls, wherein the cell walls preferably comprise boron nitride sheets and optionally a polymer binder. With respect to foam structures, those skilled in the art will appreciate that a cell within a foam defines a pore or opening within the foam structure. The cells of the boron nitride foam are open cells, in that the pore or opening which the cells define is not fully encased by a cell wall. In other words, the cell has an opening in it through which matter such as gas or liquid can pass. Usually the cells will have two separate openings through which matter such as gas or liquid can pass.

It is to be understood that open cell boron nitride foams can include some amount of closed cells. Thus, in some embodiments, the foam comprises greater than 40% of open cells, for example at least 60% open cells, or at least 70% open cells, or at least 80% open cells, or at least 90% open cells. In some embodiments, substantially all cells in the boron nitride foam are open cells.

The open cells of the boron nitride foam are interconnected. As used herein, the term “interconnected” cells means that a cell wall that defines a given cell also defines at least part of an adjacent cell. In other words, the open cells in the foam share common cell walls. A cell at the edge of a foam structure can have a cell wall that is not common with an adjacent cell. Thus, a feature of the open cells within the boron nitride foam is that they are defined by the cell walls. The term “cell wall(s)” as used herein refers to a structural feature that defines the volume of the cells. In certain embodiments, the cells are at least partially enclosed, despite being interconnected, which can also be referred as being alveolar or capsular in character.

Each open cell of the boron nitride foam has a pore size. The size of the individual cells defined by the cell walls can vary widely, even within the same sample. The diameter of an individual cell in a sample can be determined, for example, by scanning electron microscopy (SEM) of a cross-section of the sample. As used herein, the term “pore size” refers to the distance presented by the largest diameter of a given cell in a cross-sectional sample of the foam. As the cross sectional shape of a given cell may not be circular, reference to the cross sectional “diameter” is intended to mean the largest cross sectional distance between the cell walls. As there may be slight variation in pore size of a given boron nitride foam, it is often more convenient to refer to the average pore size. In an embodiment the open cells have an average pore size of 0.1 micrometer (μm) to 1 millimeter (mm), or 0.5 μm to 1 mm, depending on the manufacturing conditions. In some embodiments the average pore size can be 1 to 100 μm, or 10 to 80 μm, or 20 to 60 μm.

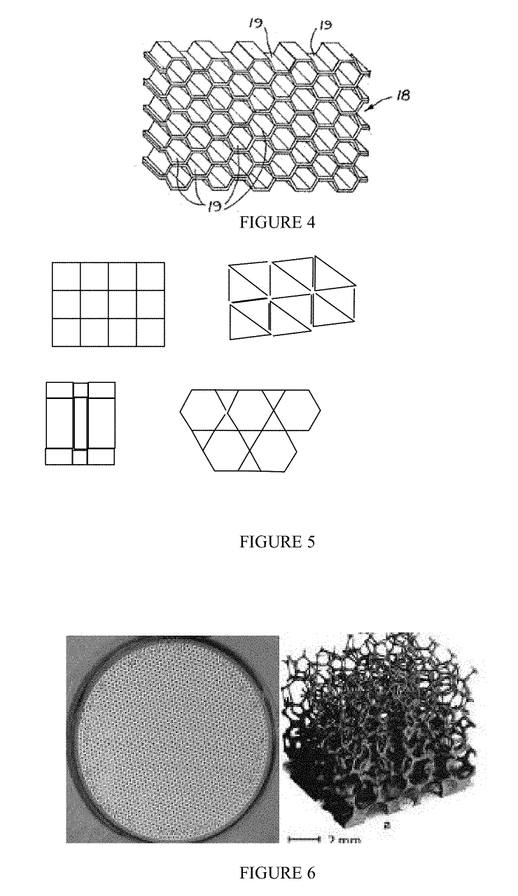

In addition to the cell walls being interconnected, the open cells of the boron-nitride foam can be essentially random or ordered to some degree. As used herein, the term “ordered” means that as viewed in any cross-section, the cells are not all randomly oriented relative to each other. In other words, upon viewing a collection of adjoining cells it is apparent that the cells are arranged in a non-random fashion. The degree of order can be lesser or greater. It is also possible for the cells to appear random in one cross-section, but ordered in another. For example, in a foam sample containing cells that are elongated in one direction, a cross-section across the short axis of the cells shows an essentially random (anisotropic) orientation, as shown in FIG. 3. However, a cross-section across the long axis of the cells shows a low degree of ordering along the longer axis of the cells, as shown in FIG. 4. Accordingly, reference to open cells being “ordered” is intended to mean a collection of adjacent cells are oriented in a similar direction along a given axis. Where the cells are ordered, their general orientation can progressively vary throughout the foam. Nevertheless, regardless of a progressive change in orientation of cells relative to each other, it will still be apparent that they are present in an ordered fashion.

With further reference to FIG. 3 and FIG. 4, it can be seen that the degree of ordering in a foam can further affect the apparent pore size of the foam. Thus, the apparent average pore size of the foam measured from the cross-section shown in FIG. 3 is less than the apparent average pore size determined from the cross section shown in FIG. 4. Because the pore sizes in an ordered foam can vary depending the cross-section analyzed, as used herein, “longest axis pore size” of an ordered foam as used herein refers to the dimension of the longest axis of the cells, i.e., the dimensions determined from a cross-section as shown in FIG. 4. In an embodiment, in an ordered foam, the cells have an average longest axis pore size of 0.1 micrometer (μm) to 1 millimeter (mm), or 0.5 μm to 1 mm, depending on the manufacturing conditions. In some embodiments the average pore size can be 1 to 100 μm, or 10 to 80 μm, or 20 to 60 μm.

In some embodiments the cell structure present in the boron nitride foams can be more ordered, or highly ordered, for example as shown in FIG. 5. FIG. 5 shows a highly ordered honeycomb structure of hexagonal cells. It is to be understood that this structure is not limiting, and that foams having a honeycomb structure can have various cross-sectional shapes and sizes as shown in FIG. 6. The edge connectivity (i.e., the number of cell wall edges that intersect together) can accordingly vary, where in some embodiments, the open cells have an edge connectivity of 3 as shown in FIG. 6. In other embodiments, the square cells shown in FIG. 6 have an edge connectivity of 4 and the triangular cells have an edge connectivity of 6. Further as shown in FIG. 5, different cell sizes can be present in the same structure. It is further to be understood that in any ordered structure, there can be degrees of structural irregularities that deviate from the generally ordered structure.

In the solid polymer-reinforced boron nitride foam, the boron nitride sheets are not only present as a plurality of layers to define the thickness of the cell wall, but some of the layered sheets can also only partially overlap. Accordingly, the cell walls can be constructed of a plurality of layered boron nitride sheets, some of which can only partially overlap. Despite some of the boron nitride sheets only partially overlapping within the layered structure, the thickness of the cell wall will nevertheless be defined by at least two layered boron nitride sheets. As there may be slight variations in cell wall thickness across each cell in a given foam, it is usually more convenient to refer to the average cell wall thickness. The average cell wall thickness can vary widely, for example from 2 nm (nanometer) to 5 millimeters (mm). In some embodiments the average cell wall thickness is 0.1 micrometer to 5 millimeters, or 1 micrometer to 1 millimeter. In other embodiments, the average cell wall thickness can be 2 to 10,000 nm, or 2 to 700 nm, or 2 to 500 nm, or 2 to 250 nm, or 2 to 100 nm, or 2 to 50 nm, or 2 to 30 nm. The cell walls can comprise any number of hexagonal boron nitride sheets more than one. For example, the cell walls can comprise 2 to 1,000 hexagonal boron nitride sheets, or 2 to 100 hexagonal boron nitride sheets, or 2 to 50 hexagonal boron nitride sheets.

In some embodiments, the average cell wall thickness of the foam is less than the average pore size of a random foam, or less than the longest axis pore size of an ordered foam. For example, the ratio of the average wall thickness to the average pore size can be 1:50 to 1:25,000. In some embodiments, the ratio of the average wall thickness to the average pore size of a random foam can be 1:100 to 1:10,000, or 1:500 to 1:8,000, or 1:1,000 to 1:8,000. In other embodiments, the ratio of the average wall thickness to the longest axis pore size of an ordered foam can be 1:100 to 1:10,000, or 1:500 to 1:8,000, or 1:1,000 to 1:8,000.

It will be appreciated that structural features of the foam such as the pore size and cell wall thickness can influence the overall density of the boron nitride foam. These foams can advantageously be prepared to exhibit a variety of densities including a very low density. For example, the foams can be prepared having a density of only 0.5 mg/cm³. Surprisingly, even at such low densities the foams can still exhibit improved properties such as excellent elasticity. In an embodiment, the density of the boron nitride foam is 0.5 to 2,000 mg/cm³, or 0.5 to 700 mg/cm³, or 0.5 to 500 mg/cm³, or 0.5 to 100 mg/cm³. In other embodiments the density of the boron nitride foam is 0.5 to 50 mg/cm³, or 0.5 to 10 mg/cm³, or 0.5 to 7 mg/cm³, or 0.5 to 5 mg/cm³. In some instances, the boron nitride foam has a density of 0.5 to 2 mg/cm³.

In an aspect, the polymer-reinforced boron nitride foam is superelastic. Superelasticity, sometimes referred to as pseudoelasticity, refers to a situation where a solid material undergoes a phase transformation that causes a reduction of the material's modulus of elasticity (Young's modulus). When mechanically loaded, a superelastic material may reversibly deform to very high strains. A superelastic material can have complete recovery after a 100 cycle compression exceeding 70% strain. That is, a superelastic material can completely recover its original shape after it is compressed 100 times at over 70% deformation each time.

The boron nitride foams can advantageously exhibit improved mechanical properties. For example, the foams or compositions comprising the foams can exhibit excellent structural elasticity. The structural elasticity of the foams can be observed when measuring their compression set. As used herein, the term “compression set” means a measurement of the permanent deformation remaining after release of a compressive stress that is applied to the foam or composition. Compression set is expressed as the percentage of the original deflection (i.e., a constant deflection test). Accordingly, a test specimen of the boron nitride foam or composition comprising the boron nitride foam is compressed at a nominated % for one minute at 25° C. Compression set is taken as the % of the original deflection after the specimen is allowed to recover at standard conditions for 30 minutes. The compression set value C can be calculated using the formula [(t₀-tᵢ)/(t₀-tₙ)]×100, where t₀ is the original specimen thickness, tᵢ is the specimen thickness after testing, and tₙ is the spacer thickness which sets the % compression that the foam is to be subjected. For comparative results, the specimens to be tested should have the same dimensions, e.g., where the diameter is 12 mm, and the height is 8 mm. The compression set measurement is based on that outlined in ASTM D395.

In some embodiments, the boron nitride foam has a compression set at 15% compression of 20% or less, or 15% or less, or 10% or less. In other words, the foam specimen can be compressed 15% of its volume or height and upon release of the compressive stress the 15% deflection in the foam recovers by at least 97%, or at least 97.8%, or at least 98.5%.

In some embodiments, the boron nitride foam has a compression set at 30% compression of 20% or less, or 15% or less, or 10% or less. In some embodiments, the boron nitride foam has a compression set at 50% compression of 15% or less, or 10% or less, or 7% or less. In some embodiments, the boron nitride foam has a compression set at 70% compression of 15% or less, or 10% or less, or 7% or less. In some embodiments, the boron nitride foam has a compression set at 80% compression of 15% or less, or 10% or less, or 5% or less. In some embodiments, the boron nitride foam has a compression set at 90% compression of 15% or less, or 10% or less, or 5% or less. In some embodiments, the boron nitride foam has a compression set at 95% compression of 15% or less, or 10% or less, or 5% or less.

In practical terms, the elastic properties of the boron nitride foams enable the foam to be highly compressed and yet have the ability to return into its original shape.

The boron nitride foams can advantageously exhibit improved thermal conductivity and dielectric properties. Accordingly, the boron nitride foams can have a thermal conductivity of 1 W/m·K or more, specifically as 2 W/m·K, or more, or 4 W/m·K or more, for example a thermal conductivity of 1 to 300 W/m·K, specifically 10 to 200 W/m·K, determined according to ASTM E1461.

The foam can have a dielectric constant of less than or equal to 2. The foam can have a dielectric loss of less than or equal to 0.03. These properties can be attained at a very low foam density.

The boron nitride foams are useful in a wide variety of applications, in particular applications that involve thermal management material, such as thermal pads, electrodes for energy storage, and in conversion devices such as supercapacitors, fuel cells, and batteries, in capacitive desalination devices, in thermal and acoustic insulators, specifically thermal insulation composites, in chemical or mechanical sensors, in biomedical applications, in actuators, in adsorbents, as catalyst supports, in field emission, in mechanical dampening, as filters, in three dimensional flexible electronic components, circuit materials, integrated circuit packages, printed circuit boards, electronic device, cosmetic products, wearable electronics, high efficiency flexible electronics, power electronics, high frequency materials and energy storage materials.

The boron nitride foams are useful as ceramic battery separators, due to their well-controlled pore structure, high temperature stability, and chemical stability. The boron nitride foams are expected to provide heat spreading when included in battery packs. In addition, the boron nitride foams are useful in applications requiring high frequency materials. Another application is in stretchable/wearable electronics.

The invention is further illustrated by the following embodiments.

### Embodiment 1

A method of preparing a boron nitride foam, the method comprising flowing a gaseous medium along a flow path; introducing into the flow path a flowable composition comprising boron nitride sheets, a suspending agent, and optionally a surfactant to foam the flowable composition in the flow path; outputting the foamed flowable composition from the flow path; and solidifying the outputted flowable composition to provide the boron nitride foam; wherein the boron nitride foam comprises a structure defined by a three-dimensional network of interconnected cells defined by cell walls, wherein the cell walls comprise the boron nitride sheets.

### Embodiment 2

The method of embodiment 1, wherein the flowable composition comprises a polymer binder composition or a polymer binder precursor composition, and the boron nitride foam is a polymer-reinforced boron nitride foam.

### Embodiment 3

The method of embodiment 2, wherein the suspending agent comprises a solvent for the binder composition or the polymer binder precursor composition.

### Embodiment 4

The method of embodiment 3, wherein the solvent comprises xylene, toluene, methyl ethyl ketone, methyl isobutyl ketone, hexane, heptane, octane, nonane, cyclohexane, isophorone, a terpene-based solvent, or a combination comprising at least one of the foregoing.

### Embodiment 5

The method of any one or more of embodiments 2-4, wherein the polymer binder composition comprises a thermoplastic polymer or a thermoset polymer, and optionally a surfactant, preferably wherein the thermoplastic polymer is polypropylene, polystyrene, polyurethane, silicone, polyolefin, polyester, polyamide, fluorinated polymer, polyalkylene oxide, polyvinyl alcohol, ionomer, cellulose acetate, or a combination comprising at least one of the foregoing.

### Embodiment 6

The method of any one or more of embodiment 2-4, wherein the polymer binder precursor composition comprises a curable thermosetting polymer, a surfactant, and a catalyst for cure of the thermosetting polymer, preferably a polyurethane curable composition.

### Embodiment 7

The method of any one or more of embodiments 5 and 6, wherein the surfactant is present, and is preferably a nonionic surfactant.

### Embodiment 8

The method of any one or more of embodiments 1-7, wherein the flow path is through a channel and wherein the flowable composition is flowed into the channel through an inlet to the channel.

### Embodiment 9

The method of embodiment 8, wherein foaming comprises flowing the gaseous medium through a constriction which provides bubbles in the flowable composition.

### Embodiment 10

The method of any one or more of embodiments 1-9, wherein the flowing the gaseous medium is done at constant speed.

### Embodiment 11

The method of any one or more of embodiments 1-10, wherein the boron nitride sheets are hexagonal boron nitride sheets.

### Embodiment 12

The method of any one or more of embodiments 1-11, wherein solidifying the outputted flowable foamed composition is done in a container that provides a shape to the boron nitride foam.

### Embodiment 13

The method of any one or more of embodiments 1-12, wherein solidifying the outputted flowable foamed composition is done by cooling or curing.

### Embodiment 14

The method of any one or more of embodiments 1-13, wherein the boron nitride foam is superelastic.

### Embodiment 15

The method of embodiment 14, wherein the superelastic foam has complete recovery after a 100 cycle compression exceeding 70% strain.

### Embodiment 16

The method of any one or more of embodiments 1-15, wherein the boron nitride foam has a density of 0.5 to 2000 mg/cm³.

### Embodiment 17

The method of any one or more of embodiments 1-16, wherein the boron nitride foam has a compression set at 50% compression of 15% or less.

### Embodiment 18

The method of any one or more of embodiments 1-17, wherein the boron nitride foam has a thermal conductivity of 1 W/m·K or more, specifically 1 to 300 W/m·K, determined according to ASTM E1461.

### Embodiment 19

The method of any one or more of embodiments 1-18, wherein the boron nitride foam has a dielectric constant less than or equal to 2.

### Embodiment 20

The method of any one more of embodiments 1-19, wherein the boron nitride foam has a dielectric loss less than or equal to 0.003.

### Embodiment 21

The method of any one or more of embodiments 1-20, wherein the cell walls have an average thickness of 2 nanometers to 5 millimeters; or from 0.1 micrometer to 5 millimeters, or 1 micrometer to 1 millimeter; or from 2 nanometers to 0.01 millimeters, or from 2 nanometers to 1,000 micrometers.

In general, the compositions, articles, and methods described here can alternatively comprise, consist of, or consist essentially of, any components or steps herein disclosed. The articles and methods can additionally, or alternatively, be manufactured or conducted so as to be devoid, or substantially free, of any ingredients, steps, or components not necessary to the achievement of the function or objectives of the present claims.

“Alkyl” as used herein means a straight or branched chain saturated aliphatic hydrocarbon having the specified number of carbon atoms. “Aryl” means a cyclic moiety in which all ring members are carbon and at least one ring is aromatic, the moiety having the specified number of carbon atoms. More than one ring can be present, and any additional rings can be independently aromatic, saturated or partially unsaturated, and can be fused, pendant, spirocyclic or a combination comprising at least one of the foregoing.

“All ranges disclosed herein are inclusive of the endpoints, and the endpoints are independently combinable with each other. “Combination” is inclusive of blends, mixtures, alloys, reaction products, and the like. “Or” means “and/or.” The terms “a” and “an” and “the” do not denote a limitation of quantity, and are to be construed to cover both the singular and the plural, unless otherwise indicated herein or clearly contradicted by context. Unless defined otherwise, technical and scientific terms used herein have the same meaning as is commonly understood by one of skill in the art to which this invention belongs. In addition, it is to be understood that the described elements may be combined in any suitable manner in the various embodiments.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications, variations, improvements, and substantial equivalents.

What is claimed is:

1. A method of preparing a boron nitride foam, the method comprising flowing a gaseous medium along a flow path;
introducing into the flow path a flowable composition comprising
boron nitride sheets,
a suspending agent, and
optionally a surfactant
to foam the flowable composition in the flow path;
outputting the foamed flowable composition from the flow path; and
solidifying the outputted flowable composition to provide the boron nitride foam;
wherein the boron nitride foam comprises a structure defined by a three-dimensional network of interconnected cells defined by cell walls, wherein the cell walls comprise the boron nitride sheets.

2. The method of claim 1, wherein the flowable composition comprises a polymer binder composition or a polymer binder precursor composition, and the boron nitride foam is a polymer-reinforced boron nitride foam.

3. The method of claim 2, wherein the suspending agent comprises a solvent for the binder composition or the polymer binder precursor composition.

4. The method of claim 3, wherein the solvent comprises xylene, toluene, methyl ethyl ketone, methyl isobutyl ketone, hexane, heptane, octane, nonane, cyclohexane, isophorone, a terpene-based solvent, or a combination comprising at least one of the foregoing.

5. The method of claim 2, wherein the polymer binder composition comprises a thermoplastic polymer or a thermoset polymer.

6. The method of claim 2, wherein the polymer binder precursor composition comprises a curable thermosetting polymer, a surfactant, and a catalyst for cure of the thermosetting polymer.

7. The method of any claim 5, wherein the surfactant is present, and is preferably a nonionic surfactant.

8. The method of claim 1, wherein the flow path is through a channel and wherein the flowable composition is flowed into the channel through an inlet to the channel.

9. The method of claim 8, wherein foaming comprises flowing the gaseous medium through a constriction which provides bubbles in the flowable composition.

10. The method of claim 1, wherein the flowing the gaseous medium is done at constant speed.

11. The method of claim 1, wherein the boron nitride sheets are hexagonal boron nitride sheets.

12. The method of claim 1, wherein solidifying the outputted flowable foamed composition is done in a container that provides a shape to the boron nitride foam.

13. The method of claim 1, wherein solidifying the outputted flowable foamed composition is done by cooling or curing.

14. The method of claim 1, wherein the boron nitride foam is superelastic.

15. The method of claim 14, wherein the superelastic foam has complete recovery after a 100 cycle compression exceeding 70% strain.

16. The method of claim 1, wherein the boron nitride foam has a density of 0.5 to 2000 mg/cm³.

17. The method of claim 1, wherein the boron nitride foam has a compression set at 50% compression of 15% or less.

18. The method of claim 1, wherein the boron nitride foam has a thermal conductivity of 1 W/m·K or more, specifically 1 to 300 W/m·K, determined according to ASTM E1461.

19. The method of claim 1, wherein the boron nitride foam has a dielectric constant less than or equal to 2.

20. The method of claim 1, wherein the boron nitride foam has a dielectric loss less than or equal to 0.003.

21. The method of claim 1, wherein the cell walls have an average thickness of 2 nanometers to 5 millimeters.
